(19) United States
(12) Patent Application Publication
(10) Pub. No.: US 2013/0082046 A1
(43) Pub. Date: Apr. 4, 2013

(54) INDUCTION-HEATING COOKER

(71) Applicants: Fumitaka Ogasawara, Hyogo (JP); Shintaro Noguchi, Hyogo (JP); Teruo Hayashinaka, Hyogo (JP)

(72) Inventors: Fumitaka Ogasawara, Hyogo (JP); Shintaro Noguchi, Hyogo (JP); Teruo Hayashinaka, Hyogo (JP)

(73) Assignee: PANASONIC CORPORATION, Kadoma-shi, Osaka (JP)

(21) Appl. No.: 13/702,939

(22) PCT Filed: Jun. 9, 2011
(86) PCT No.: PCT/JP2011/003259

§ 371 Date: Dec. 7, 2012

(30) Foreign Application Priority Data
Jun. 10, 2010 (JP) 2010-132671

(51) Int. Cl. H05B 6/06

(52) U.S. Cl. CPC H05B 6/062
USPC 219/625

(57) ABSTRACT

An induction-heating cooker includes an infrared sensor for detecting infrared rays emitted from a cooking container, a scorching detecting portion for outputting, when a temperature of the cooking container increases from a first set temperature and exceeds a second set temperature, scorching detection information based on infrared detection information of the infrared sensor in a heating mode in which a power can be set, and a loading detecting portion for detecting addition of a load such as, for example, a material to be cooked based on a change of the infrared detection information. Even if the scorching detecting portion outputs the scorching detection information before a cooking time measured from the start of a heating operation reaches a first set time, a controller continues the heating operation. If the loading detecting portion detects that the load has been added, the measured cooking time is cleared and measurement thereof is restarted.

### TECHNICAL FIELD

The present invention relates to an induction-heating cooker and, in particular, to an induction-heating cooker having a function of detecting burning or scorching of a cooking container such as, for example, a pan during cooking.

### BACKGROUND ART

Conventionally, the induction-heating cooker of this kind detects boiling after the start of heating and measures the viscosity and quantity of a food material or materials contained in a cooking container (for example, a pan) based on a temperature and an input power at the time of detection of the boiling and also on a temperature change pattern before the boiling, thereby determining a boiling or stewing power required for heating after the boiling. The conventional induction-heating cooker has a boiling or stewing mode in which when the cooking container loses soup stock during heating and the temperature of a bottom surface of the cooking container (bottom of the pan) rapidly increases over a predetermined value, a determination is made that the food material to be cooked has burnt and stuck to the bottom of the pan (see, for example, Patent Document 1).

FIG. 14 is a block diagram of the conventional induction-heating cooker and FIG. 15 is a flowchart indicating operation of the conventional induction-heating cooker as shown in FIG. 14.

In FIG. 14, a top plate 102 is a crystallized ceramic plate provided atop the induction-heating cooker and a heating coil 103 is disposed below the top plate 102. When a pan or cooking container 101 is heated, the pan 101 is placed on the top plate 102 so that a bottom of the pan 101 may confront the heating coil 103. An inverter circuit 108a includes switching elements and resonance capacitors and supplies the heating coil 103 with a high-frequency current. The inverter circuit 108a and the heating coil 103 constitute an inverter. A controller 107 performs an on-off control with respect to the switching elements of the inverter circuit 108a to control a heating power. In order to detect a temperature of the pan 101 employed as the cooking container, a thermistor 104 is provided on a rear surface of the top plate 102, on which the pan 101 is placed, to detect a temperature of the rear surface of the top plate 102. The thermistor 104 outputs to the controller 107 a detection signal obtained by measuring the temperature of the rear surface of the top plate 102. An operating portion 110 to be used by a user is provided with a power setting portion 110a, a heating start key 110b for starting a heating operation, and a control mode selection key 110c for selecting an operation mode. The power setting portion 110a is provided with a power down key 110aa for reducing a power set value by one step every time it is depressed in a heating mode and a power up key 110ab for increasing the power set value by one step every time it is depressed.

Operation of the conventional induction-heating cooker of the above-described construction is explained hereinafter with reference to FIG. 15. When a power switch 106 is turned on (S301), the controller 107 enters a standby mode. When the controller 107 is in the standby mode, the heating operation is at a stop and one of a plurality of operation modes including the stewing mode can be selected by operating the control mode selection key 110c of the operating portion 110. Upon selection of the operation mode in the standby mode (S302), when the heating start key 110b is depressed (S303), the heating operation is started in the operation mode so selected. By way of example, when the heating operation is started upon selection of the stewing mode (YES at S304), the controller 107 forbids the power setting portion 110 to change the power set value and the heating power is automatically controlled after the boiling detection operation, as disclosed in Patent Document 1. If an abnormal increase in temperature of the pan 101 has been detected based on the control signal from the thermistor 104, a scorching detection function of a scorching detecting portion 105 for detecting scorching operates (S306). When the heating operation is started upon selection of, for example, the heating mode and not the stewing mode (NO at S304), the controller 107 forbids the operation of the scorching detection function (S305). In this event, the power setting portion 110a is allowed to change the power set value.
Patent Document 1: Japanese Laid-Open Patent Publication No. 10-149875

### SUMMARY OF THE INVENTION

### Problems to be Solved by the Invention

However, in the conventional induction-heating cooker of the above-described construction, a cooking mode in which the scorching detection function operates is limited to the stewing mode, in which the power setting portion 110a is forbidden to change the power set value. That is, the user cannot make the scorching detection function active in the heating mode in which the power set value can be changed by the power setting portion 110a. Accordingly, in order for the user to make the scorching detection function active in the induction-heating cooker, he or she is forced to select the stewing mode. In the stewing mode, there is no abrupt increase in temperature of the cooking container in the absence of scorching and an abrupt increase in temperature is caused by the occurrence of scorching. For this reason, the scorching can be detected by detecting an abrupt temperature increase in the stewing mode. In another operation mode (heating mode), the temperature of the pan 101 does not change constantly depending on the kind of cooking and sometimes abruptly reaches a high temperature, thus making it difficult to correctly detect the scorching.

The present invention has been developed to overcome the above-described disadvantages inherent in the conventional induction-heating cooker of the above-described construction. It is accordingly an objective of the present invention to provide an induction-heating cooker capable of not only making the scorching detection function active, if necessary, even in the heating mode, in which the user can freely select the heating power, but also forbidding the scorching detection function if there is a possibility that the scorching detection function is unnecessarily made active to adversely affect the cooking. That is, the objective of the present invention is to provide a user-friendly induction-heating cooker capable of limiting the adverse effect on the normal cooking in the heating mode and preventing the extent of scorching from becoming worse.

### Means to Solve the Problems

The induction-heating cooker according to the present invention is intended to solve the problems inherent in the above-described conventional induction-heating cooker and includes a top plate adapted to place a cooking container thereon, an inverter circuit disposed below the top plate and having a heating coil to heat the cooking container, an infrared sensor disposed below the top plate to detect infrared rays that are emitted from a bottom surface of the cooking container and pass through the top plate, the infrared sensor outputting infrared detection information corresponding to a temperature of the bottom surface of the cooking container, a scorching detecting portion operable to detect scorching, in which a material to be cooked has burnt and stuck to the bottom surface of the cooking container, based on the infrared detection information, the scorching detecting portion outputting scorching detection information, an output setting portion operable to select one of a plurality of different power set values, and a controller operable to supply the heating coil with a high-frequency current and control a heating operation of the inverter circuit such that a heating power becomes a power set value selected. The controller includes a first time measuring portion operable to measure a cooking time from the start of heating by the inverter circuit and a loading detecting portion operable to detect addition of a load to the cooking container based on the infrared detection information outputted from the infrared sensor. If the cooking time measured by the first time measuring portion does not reach a first set time, the heating operation is continued even if the scorching detecting portion outputs the scorching detection information, and when the loading detecting portion detects that the load has been added, the cooking time measured by the first time measuring portion is reset and measurement thereof is restarted.

The induction-heating cooker of the above-described construction according to the present invention can detect scorching in the heating mode, in which the cooking container is heated at a heating power selected by the user, and prevent the state of scorching from becoming worse. Also, the induction-heating cooker according to the present invention can avoid the scorching detecting function from working to unnecessarily stop the heating operation or reduce the heating power in a relatively short-time heating operation such as when boiling water or stir-frying or during time-consuming cooking such as stir-frying or baking in which a food material or materials are added, mixed or turned over during cooking. As such, the induction-heating cooker according to the present invention allows the user to continue the cooking without any feeling of strangeness and prevents the usability thereof from deteriorating.

In the following means to solve the problems, specific constituent elements, signals and the like are attached with reference numerals or characters as in embodiments described hereinafter for ease of comprehension, but the present invention is not limited to the embodiments.

In a first aspect of the present invention, the induction-heating cooker includes: a top plate (1) adapted to place a cooking container (2) thereon; an inverter circuit (8) disposed below the top plate and having a heating coil (3) to heat the cooking container; an infrared sensor (4) disposed below the top plate to detect infrared rays that are emitted from a bottom surface of the cooking container and pass through the top plate, the infrared sensor outputting infrared detection information (A) corresponding to a temperature of the bottom surface of the cooking container; a scorching detecting portion (50) operable to detect scorching, in which a material to be cooked has burnt and stuck to the bottom surface of the cooking container, based on the infrared detection information (A), the scorching detecting portion outputting scorching detection information (B); an output setting portion (14) operable to select one of a plurality of different power set values; and a controller (15) operable to supply the heating coil with a high-frequency current and control a heating operation of the inverter circuit such that a heating power becomes a power set value selected. The controller (15) includes a first time measuring portion (31) operable to measure a cooking time (Tp) from the start of heating by the inverter circuit and a loading detecting portion (33) operable to detect addition of a load to the cooking container (2) based on the infrared detection information (A) outputted from the infrared sensor (4). If the cooking time (Tp) measured by the first time measuring portion does not reach a first set time (T1), the heating operation is continued even if the scorching detecting portion outputs the scorching detection information (B), and when the loading detecting portion detects that the load has been added, the cooking time (Tp) measured by the first time measuring portion is reset and measurement thereof is restarted.

The induction-heating cooker of the above-described construction according to the first aspect of the present invention can discriminate between the cooking by boiling or stewing and other styles of cooking (for example, stir-frying) in the heating mode. In the case of the cooking by boiling or stewing, it is possible to prevent, upon detection of scorching, the state of scorching from becoming worse. Also, during short-time cooking compared with the cooking by stewing or during cooking such as stir-frying or baking in which a food material or materials are mixed or turned over, the scorching detection function does not work unnecessarily, thus making it possible to enhance the usability.

In the induction-heating cooker according to a second aspect of the present invention, the loading detecting portion (33) as set forth in the first aspect determines that the load has been added when a state in which the infrared detection information (A) outputted from the infrared sensor (4) reduces a predetermined value or more continues for a predetermined period of time. In the induction-heating cooker of this construction according to the second aspect, the scorching detection function does not work unnecessarily during, for example, stir-frying in which food materials are mixed and, hence, the infrared detection information (A) detected by the infrared sensor (4) changes largely, thus making it possible to enhance the usability.

In the induction-heating cooker according to a third aspect of the present invention, the loading detecting portion (33) as set forth in the first aspect determines that the load has been added unless the infrared detection information (A) detected by the infrared sensor (4) increases for a predetermined period of time or more. In the induction-heating cooker of this construction according to the third aspect, the scorching detection function does not work unnecessarily during, for example, baking in which a food material or materials are turned over and, hence, the infrared detection information (A) detected by the infrared sensor (4) is less likely to increase, thus making it possible to enhance the usability.

In the induction-heating cooker according to a fourth aspect of the present invention, the controller as set forth in the first or second aspect controls, if the cooking time (Tp) measured by the first time measuring portion is below the first set time (T1) and when the scorching detecting portion (50) outputs the scorching detection information (B), the heating operation of the inverter circuit for temperature control such that the infrared detection information (A) approaches a second set value without exceeding the second set value, and a criterion of the loading detecting portion (33) for detecting addition of the load is increased compared with a case where no temperature control is conducted. In the induction-heating cooker of this construction according to the fourth aspect, the scorching detection function does not work unnecessarily during, for example, short-time stir-frying. Also, even if a food material begins scorching, the progress of scorching is minimized and, instead, loading detection works frequently, thus making it possible to avoid the scorching detection function from not working normally.

In the induction-heating cooker according to a fifth aspect of the present invention, after the cooking time measured by the first time measuring portion (31) as set forth in any one of the first to fourth aspects has exceeded the first set time, if the loading detecting portion (33) detects that the load has been added, the cooking time measured by the first time measuring portion (31) is reset and measurement thereof is restarted. In the induction-heating cooker of this construction according to the fifth aspect, even in the case of relatively time-consuming cooking such as, for example, stir-frying or baking in which food materials are mixed or turned over or continual cooking, the scorching detection function does not work unnecessarily, thus making it possible to enhance the usability.

### Effects of the Invention

Even if a user selects a heating power to cook a food material or materials by boiling or stewing upon selection of a heating mode different from a stewing mode, the induction-heating cooker according to the present invention can detect scorching to automatically stop or reduce a heating operation to thereby prevent a state of scorching from becoming worse. Also, during short-time cooking such as, for example, stir-frying or during cooking in which a food material or materials are mixed or turned over, the scorching detection function does not work unnecessarily, thus making it possible to enhance the usability.

### BRIEF DESCRIPTION OF THE DRAWINGS

FIG. 1 is a block diagram showing an entire construction of an induction-heating cooker according to a first embodiment of the present invention.

FIG. 2 is a circuit diagram showing a schematic construction of an infrared sensor used in the induction-heating cooker according to the first embodiment.

FIG. 3 is a graph showing output characteristics of the infrared sensor in the induction-heating cooker according to the first embodiment.

FIG. 4 is a graph showing a relationship between a temperature detected by the infrared sensor and an elapsed time after the start of heating in the induction-heating cooker according to the first embodiment.

FIG. 5A is a graph showing a relationship between the infrared sensor-detected temperature and the elapsed time after the start of heating in the induction-heating cooker according to the first embodiment.

FIG. 5B is a graph showing a relationship between an output power W and the elapsed time after the start of heating in the induction-heating cooker according to the first embodiment.

FIG. 6A is a graph showing a relationship between the infrared sensor-detected temperature and the elapsed time when addition of a load is detected after the start of heating in the induction-heating cooker according to the first embodiment.

FIG. 6B is a graph showing a relationship between the output power W and the elapsed time when addition of the load is detected after the start of heating in the induction-heating cooker according to the first embodiment.

FIG. 7 is a flowchart indicating a loading detecting operation when a temperature reduces in the induction-heating cooker according to the first embodiment.

FIG. 8 is a flowchart indicating the loading detecting operation when no temperature increase occurs in the induction-heating cooker according to the first embodiment.

FIG. 9A is a graph showing a relationship between the infrared sensor-detected temperature and the elapsed time after the start of heating in an induction-heating cooker according to a second embodiment of the present invention.

FIG. 9B is a graph showing a relationship between the output power and the elapsed time after the start of heating in the induction-heating cooker according to the second embodiment.

FIG. 9C is a graph showing a relationship between a predetermined temperature reduction for detection of load addition and the elapsed time after the start of heating in the induction-heating cooker according to the second embodiment.

FIG. 10A is a graph showing a relationship between the infrared sensor-detected temperature and the elapsed time after the start of heating in an induction-heating cooker according to a third embodiment of the present invention.

FIG. 10B is a graph showing a relationship between the output power and the elapsed time after the start of heating in the induction-heating cooker according to the third embodiment.

FIG. 11 is a block diagram showing an entire construction of an induction-heating cooker according to a fourth embodiment of the present invention.

FIG. 12 is a graph showing an example of a rise time measuring operation and a temperature reduction calculating operation of a scorching detecting portion in the induction-heating cooker according to the fourth embodiment.

FIG. 13A is a graph showing an example of determination values used in the scorching detecting operation of the scorching detecting portion in the induction-heating cooker according to the fourth embodiment.

FIG. 13B is a graph showing another example of the determination values used in the scorching detecting operation of the scorching detecting portion in the induction-heating cooker according to the fourth embodiment.

FIG. 14 is a block diagram showing a construction of a conventional induction-heating cooker.

FIG. 15 is a flowchart indicating operation of the conventional induction-heating cooker.

### DETAILED DESCRIPTION OF THE PREFERRED EMBODIMENTS

Embodiments of an induction-heating cooker according to the present invention are described hereinafter with reference to the drawings, but the present invention is not limited to specific constructions as described in the following embodiments and includes those constructed based on a technical idea analogous to the technical idea explained in the following embodiments and also on a technical common knowledge in this technical field.

### Embodiment 1

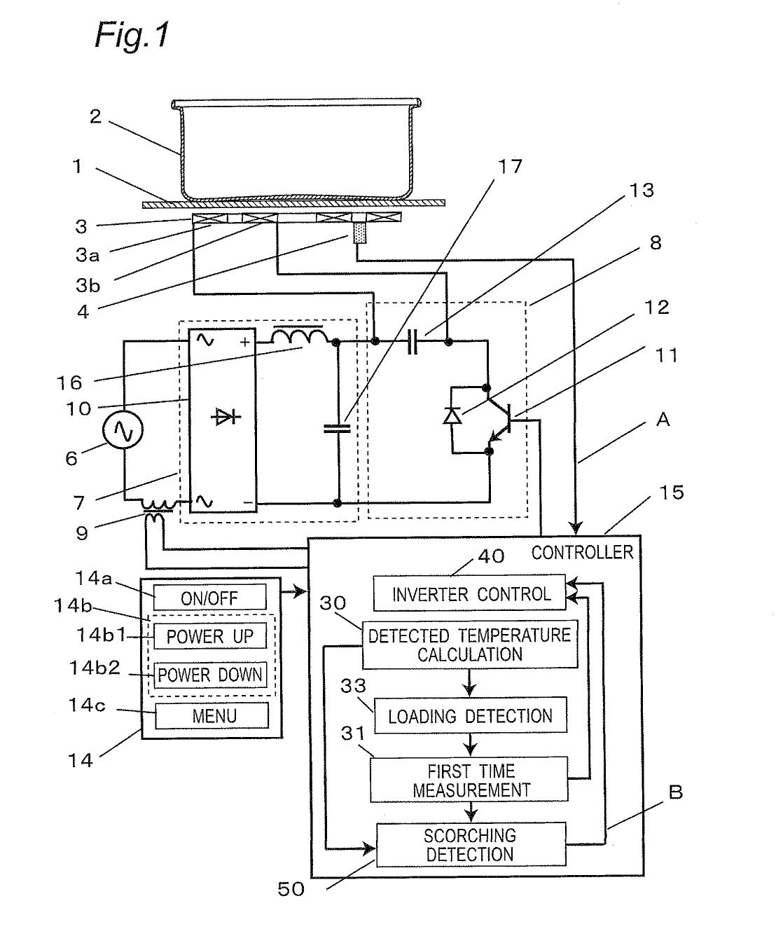

FIG. 1 is a block diagram showing an entire construction of an induction-heating cooker according to a first embodiment of the present invention. As shown in FIG. 1, the induction-heating cooker according to the first embodiment includes a ceramic top plate 1 provided atop the induction-heating cooker and a heating coil 3 (an outer coil 3a and an inner coil 3b) for induction-heating a cooking container 2 placed on the top plate 1 by generating a high-frequency magnetic field. The top plate 1 is made of an electric insulator such as, for example, glass and transmits infrared rays. The heating coil 3 is an induction-heating coil disposed below the top plate 1. The heating coil 3 is concentrically divided into two and includes an outer coil 3a and an inner coil 3b. An interspace is formed between an inner edge of the outer coil 3a and an outer edge of the inner coil 3b. The cooking container 2 placed on the top plate 1 is heated by eddy currents that have been created by the high-frequency magnetic field generated by the heating coil 3.

The top plate 1 is provided with an operating portion 14 positioned on a user's side to allow a user to perform various operations such as start/stop of a heating operation, settings and the like. A display (not shown) is provided between the operating portion 14 and a region for placing the cooking container 2 thereon.

In the induction-heating cooker according to the first embodiment, an infrared sensor or cooking container temperature detector 4 is provided below the interspace between the outer coil 3a and the inner coil 3b. It is to be noted that in the induction-heating cooker of the present invention the mounting position of the infrared sensor 4 is not limited to that described in the first embodiment and may be a position where the temperature of the cooking container 2 can be correctly detected. Infrared rays emitted from a bottom surface of the cooking container 2 represent the temperature thereof and pass through the top plate 1 and through the interspace between the outer coil 3a and the inner coil 3b before they enter and are received by the infrared sensor 4. The infrared sensor 4 detects the infrared rays so received and outputs an infrared detection signal A as infrared detection information based on the amount of detected infrared rays.

A commutating and smoothing portion 7 for converting an alternating-current voltage supplied from a commercial power source 6 to a direct-current voltage and an inverter circuit 8 for generating a high-frequency current upon supply of the direct-current voltage from the commutating and smoothing portion 7 and for outputting the generated high-frequency current to the heating coil 3 are provided below the heating coil 3. Also, an input current detecting portion 9 (CT) is provided between the commercial power source 6 and the commutating and smoothing portion 7 to detect an input current that flows from the commercial power source 6 to the commutating and smoothing portion 7.

The commutating and smoothing portion 7 includes a full-wave rectifier 10 made up of a diode bridge and a low-pass filter connected between output terminals of the full-wave rectifier 10 and having a choke coil 16 and a smoothing capacitor 17. The inverter circuit 8 includes a switching element 11 (IGBT is used in the first embodiment), a diode 12 connected inverse-parallel to the switching element 11, and a resonance capacitor 13 connected parallel to the heating coil 3. When the switching element 11 of the inverter circuit 8 is turned on and off, the high-frequency current is generated. The inverter circuit 8 and the heating coil 3 constitute a high-frequency inverter.

The induction-heating cooker according to the first embodiment also includes a controller 15 for controlling the high-frequency current supplied from the inverter circuit 8 to the heating coil 3 by controlling on/off actions of the switching element 11 of the inverter circuit 8. The controller 15 controls the high-frequency current of the heating coil 3 based on an operation mode setting signal and a heating condition setting signal from the operating portion 14 and on the infrared detection signal A detected by the infrared sensor 4 to thereby control electric energy to be applied to the cooking container 2.

The controller 15 includes an inverter control portion 40 for controlling the on/off actions of the switching element 11 based on the operation mode setting signal and the heating condition setting signal transmitted from the operating portion 14, the infrared detection signal A (for example, a voltage signal) from the infrared sensor 4, and the like. The controller 15 also includes a detected temperature calculating portion 30 for converting the infrared detection signal A of the infrared sensor 4 into a temperature to output a detected temperature signal, a first time measuring portion 31 for measuring a cooking time from the start of heating, and a loading detecting portion 33 for detecting introduction of a load into the cooking container 2 based on a change in the detected temperature converted by the detected temperature calculating portion 30.

Although in the first embodiment of the present invention the change in the detected temperature converted by the detected temperature calculating portion 30 is utilized, the present invention is not limited to this and the loading detecting portion 33 may directly detect addition of a load without converting the infrared detection signal A of the infrared sensor 4 into the temperature.

The induction-heating cooker according to the first embodiment is provided with a scorching detecting portion 50. In the controller 15, a cooking time signal measured by the first time measuring portion 31 and a detected temperature signal created by the detected temperature calculating portion 30 are inputted to the scorching detecting portion 50, which in turn determines whether a food material or materials are being cooked by stewing or any other style of cooking (for example, stir-frying) based on the cooking time signal and the detected temperature signal. If the scorching detecting portion 50 determines that the food material is being cooked by stewing and detects that the bottom of the cooking container 2 is scorched, the scorching detecting portion 50 outputs a scorching detection signal B to the inverter control portion 40 in the controller 15.

As described above, the operating portion 14 is positioned on a front side (user's side) of the top plate 1 and the display for displaying the operation mode, the operating condition and the like is positioned between the operating portion 14 and the cooking container 2 placed on the top plate 1. The operating portion 14 includes a plurality of capacitance switches 14a-14c. The switches 14a-14c are switches for inputting instructions regarding the cooking and the number thereof is equal to the number of the heating coils 3. It is to be noted that in the present invention the switches of the operating portion 14 are not limited to the capacitance ones, but may be various switching means such as, for example, push buttons like tact switches.

Each switch 14a-14c is assigned with a specific function. By way of example, the switch 14a is an on-off switch assigned with a function of controlling start and stop of the cooking. The user inputs control instructions such as the heating condition using the operating portion 14, which is provided with a power setting portion 14b and an operation mode selection key 14c for selecting an operation mode. The power setting portion 14b is provided with a power down key 14b2 for reducing a power set value by one step and a power up key 14b1 for increasing the power set value by one step. One of a plurality of power set values (for example, setting 1=100 W, setting 2=300 W, setting 3=700 W, setting 4=1000 W, setting 5=2000 W, setting 6=3000 W) is selected by key operations of the power setting portion 14b.

When the inverter control portion 40 of the controller 15 detects depression of one of the switches 14a-14c of the operating portion 14, the inverter control portion 40 controls and drives the inverter circuit 8 depending on the switch depressed, thereby controlling the high-frequency current to be supplied to the heating coil 3.

When the on-off switch 14a is first depressed, the controller 15 enters a standby mode in which heating is at a stop. In the standby mode, an operation mode can be selected to control an operation during heating. When the operation mode selection key 14c is operated in the standby mode, one of a plurality of operation modes (heating mode, stewing mode and the like) is selected.

In the standby mode, when a heating start key 14a is depressed (selected) upon selection of the heating mode, the heating operation is started and the controller 15 automatically controls the power to be “setting 4=1000 W” to enter the heating mode. The heating mode is an operation mode in which heating is performed with a power set value selected by the user. As described above, the power setting portion 14b is provided with the power up key 14b1 and the power down key 14b2, and when the controller 15 operates in the heating mode, the power set value can be changed to a desired setting (from setting 1 to setting 6) by operating the power setting portion 14b. If the power set value is changed in the power setting portion 14b, the power setting portion 14b outputs to the controller 15 a power set signal indicating a change in the power set value. The controller 15 monitors an input current of the inverter circuit 8 in the input current detecting portion 9 including a current transformer and controls the switching element 11 constituting the inverter circuit 8 so that a heating power (infrared detection signal A) from the inverter circuit 8 may become the power set value. In this way, the heating coil 3 is supplied with a desired high-frequency current by controlling the switching element 1.

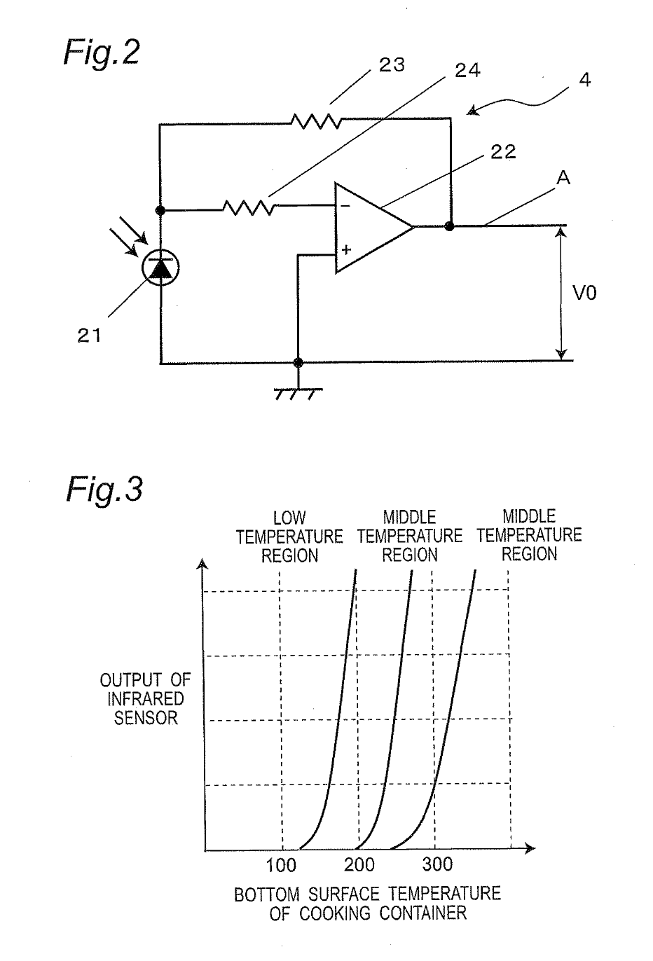

FIG. 2 is a circuit diagram showing a schematic construction of the infrared sensor 4 employed as a cooking container temperature detector and used in the induction-heating cooker according to the first embodiment. As shown in FIG. 2, the infrared sensor 4 includes a photodiode 21, an operational amplifier 22, and two resistors 23, 24. One end of each resistor 23, 24 is connected to the photodiode 21. The other end of the resistor 23 is connected to an output terminal of the operational amplifier 22 and the other end of the resistor 24 is connected to an inverted output terminal (−) of the operational amplifier 22. The photodiode 21 is a light receiving element formed of, for example, InGaAs, through which an electric current flows when infrared rays having a wavelength less than about three microns and passing through the top plate 1 hit the photodiode 21. The magnitude and the increasing rate of electric current flowing through this light receiving element increase with an increase in temperature of the infrared rays irradiated. The electric current generated by the photodiode 21 is amplified by the operational amplifier 22 and outputted to the controller 15 as the infrared detection signal A (corresponding to a voltage value V0) indicating the temperature of the cooking container 2. The infrared sensor 4 employed in the induction-heating cooker according to the first embodiment is designed to receive infrared rays emitted from the cooking container 2 and accordingly has superior thermal responsiveness, compared with a thermistor that detects the temperature through the top plate 1, thus enabling a highly accurate control.

FIG. 3 is a graph showing output characteristics of the infrared sensor 4. In FIG. 3, a horizontal axis indicates the temperature of the bottom surface of the cooking container 2 such as a pan (pan bottom temperature) and a vertical axis indicates a voltage value (V0) of the infrared detection signal A outputted from the infrared sensor 4. When infrared rays having a wavelength less than about three microns and passing through the top plate 1 hit the photodiode 21 of the infrared sensor 4, an electric current flows through the photodiode 21. Because the photodiode 21 is a light receiving element formed of, for example, InGaAs, which increases the magnitude and the increasing rate of electric current flowing therethrough with an increase in temperature of the infrared rays irradiated, if, for example, a temperature range greater than or equal to 120° C. and less than 200° C. is defined as a low temperature region, a temperature range greater than or equal to 200° C. and less than 250° C. is defined as a middle temperature region, and a temperature range greater than or equal to 250° C. and less than 330° C. is defined as a high temperature region, the temperature regions are switched in such a manner as low temperature region→middle temperature region→high temperature region by switching an amplification factor of the infrared sensor 4 with an increase in temperature (detected value) of the irradiated infrared rays.

In the induction-heating cooker according to the first embodiment, the infrared sensor 4 is switched to output an infrared detection signal AL when the temperature of the bottom surface of the cooking container 2 is greater than or equal to about 120° C. and less than 200° C., an infrared detection signal AM when the temperature of the bottom surface of the cooking container 2 is greater than or equal to about 200° C. and less than 250° C., and an infrared detection signal AH when the temperature of the bottom surface of the cooking container 2 is greater than or equal to about 250° C. and less than 330° C. The infrared sensor 4 does not output the infrared detection signal A when the temperature of the bottom surface of the cooking container 2 is less than about 120° C. “The infrared sensor 4 does not output the infrared detection signal A” in this case means that the infrared sensor 4 never outputs the infrared detection signal A and that the infrared sensor 4 does not substantially output the infrared detection signal A, i.e., the infrared sensor 4 outputs a faint signal that the controller 15 cannot substantially read a temperature change of the bottom surface of the cooking container 2 based on a change in magnitude of the infrared detection signal A. When the temperature of the cooking container 2 exceeds about 120° C., an output value of the infrared detection signal A increases in an exponential fashion.

A temperature sensor in the infrared sensor 4 is not limited to the photodiode, but may be, for example, a thermopile.

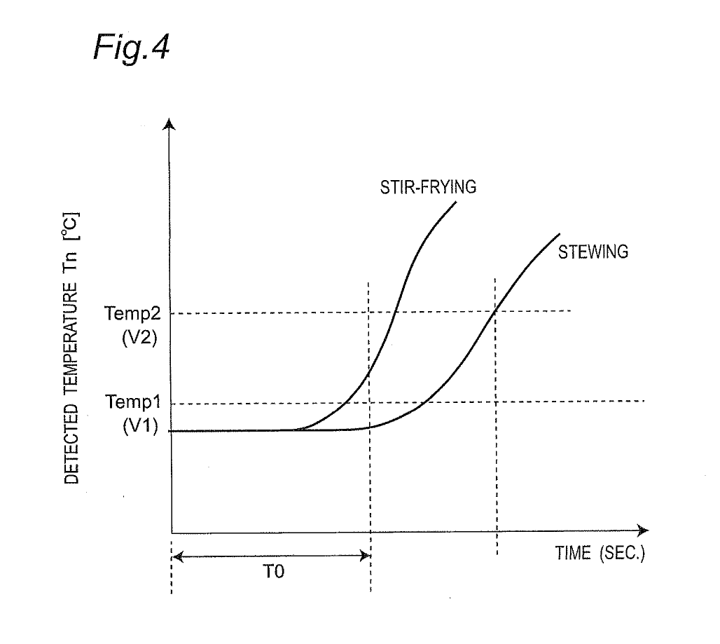

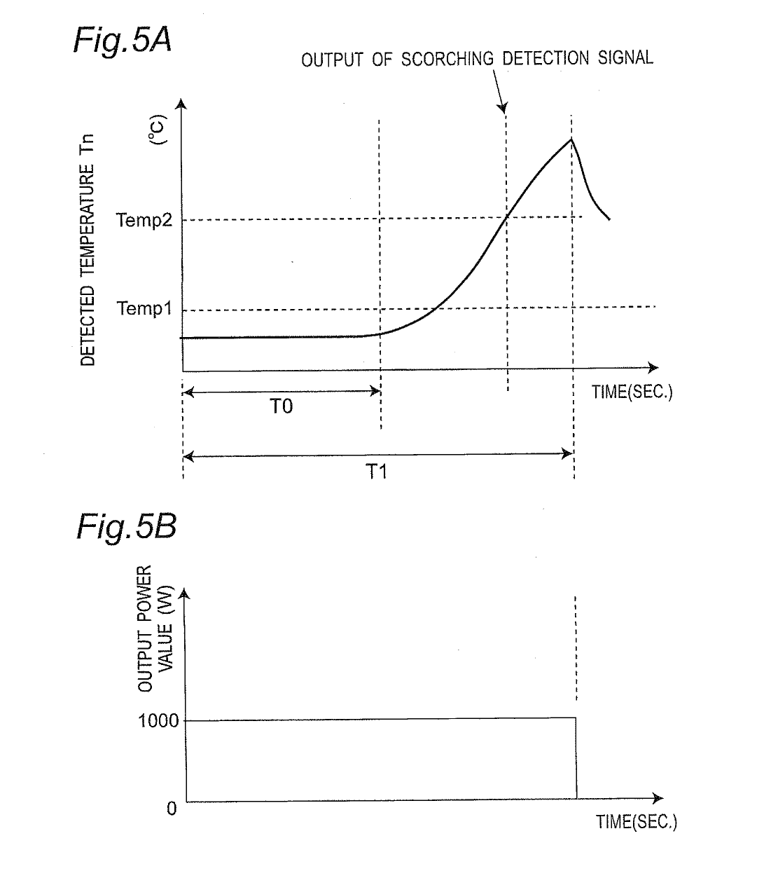

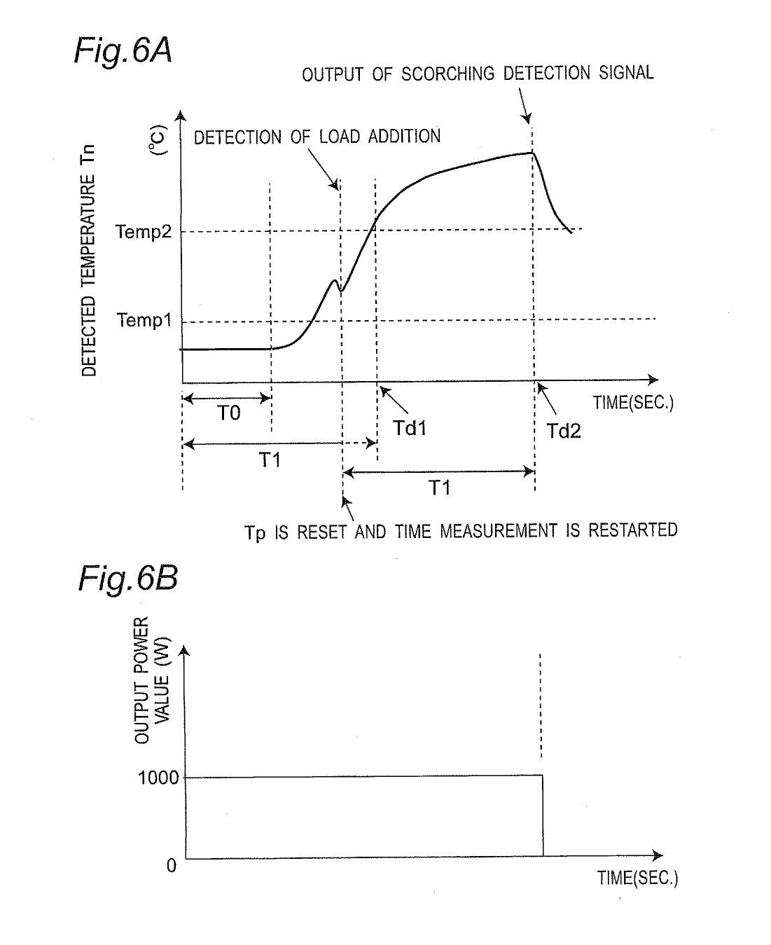

A construction of the scorching detecting portion 50 and a scorching detecting operation in the induction-heating cooker according to the first embodiment are explained hereinafter with reference to FIG. 4, FIGS. 5A and 5B, and FIGS. 6A and 6B. FIG. 4 is a graph exemplifying a detected temperature Tn to explain how to determine whether a food material or materials are being cooked by stewing or any other style of cooking (for example, stir-frying). In FIG. 4, an example of a relationship between the detected temperature Tn of the infrared sensor 4 and an elapsed time after the start of heating is shown. FIG. 5A is a graph showing an example of a relationship between the detected temperature Tn (° C.) of the infrared sensor 4 and the elapsed time (sec.) after the start of heating and FIG. 5B is a graph showing an example of a relationship between an output power (W) and the elapsed time (sec.) after the start of heating. FIGS. 6A and 6B show an example in which a load has been detected during heating. FIG. 6A is a graph showing an example of a relationship between the detected temperature Tn (° C.) of the infrared sensor 4 and the elapsed time (sec.) after the start of heating and FIG. 6B is a graph showing an example of a relationship between the output power (W) and the elapsed time (sec.) after the start of heating.

For ease of explanation, it is assumed that the output setting is “setting 4=1000 W” and not changed and that an actual output power (W) is 1000 W. The output voltage V0 of the infrared sensor 4 is inputted to the controller 15, which in turn measures the magnitude thereof and transmits the information to the scorching detecting portion 50. It is to be noted that the infrared detection signal A from the infrared sensor 4 may be directly inputted to the scorching detecting portion 50 without passing through the controller 15. The scorching detecting portion 50 is provided with a temperature memory portion (not shown) that memorizes a first output voltage V1 and a second output voltage V2 greater than the first output voltage V1 in advance.

In FIG. 4, values expressed in Celsius temperature scale are temperatures converted by the detected temperature calculating portion 30. By way of example, “Temp1 (first set temperature) (° C.)” indicating the detected temperature Tn of the cooking container 2 means a temperature (for example, about 130° C.) when the infrared sensor 4 outputs the first output voltage V1.

Similarly, “Temp2 (second set temperature) (° C.)” indicating the detected temperature Tn of the cooking container 2 means a temperature (for example, about 240° C.) when the infrared sensor 4 outputs the second output voltage V2. In the following explanation, the output voltage from the infrared sensor 4 is converted into a temperature and expressed as the detected temperature Tn of the infrared sensor 4 in Celsius temperature scale.

In FIG. 4, when the temperature of the bottom surface of the cooking container 2 heated at setting 4 (1000 W) increases, the temperature detected by the infrared sensor 4 also begins to increase. A determination is first made whether a food material or materials are being cooked by stewing or any other style of cooking (for example, stir-frying) based on the detected temperature Tn when the cooking time Tp measured by the first time measuring portion 15 from the start of heating has reached an initial set time T0 set in advance. If the food material is being cooked by stewing, it has much water compared with other styles of cooking and, hence, the temperature of the food material in the cooking container 2 is generally maintained at a temperature level of about 100° C. When water evaporates and is exhausted and the food material begins to burn, the temperature of the cooking container 2 also begins to increase. On the other hand, in the case of cooking other than stewing, if heating is continued, the temperature of the food material generally continues to increase. The determination of the kind of cooking is made based on such a difference. If the detected temperature Tn when the measured cooking time Tp has reached the initial set time T0 is higher than the first set temperature Temp1 (° C.), a determination is made that the food material has low moisture and is being cooked by, for example, stir-frying other than the stewing. If the detected temperature Tn is less than or equal to the first set temperature Temp1 (° C.), a determination is made that the food material is being cooked by stewing.

As shown in FIGS. 5A and 5B, in the case where the detected temperature Tn when the measured cooking time Tp after the start of heating has reached the initial set time T0 is less than or equal to the first set temperature Temp1 (° C.), continued heating after the determination has been made that the cooking by stewing is being done reduces moisture in the food material being cooked. The moisture in the food material is eventually exhausted and burning or scorching begins. Because the detected temperature Tn begins to increase with the progress of scorching, when the detected temperature Tn has reached the second set temperature Temp2 (° C.), the scorching detecting portion 50 determines that the scorching has occurred during stewing and outputs a scorching detection signal B.

It is essentially desirable at this stage that the controller 15 controls the inverter circuit 8 to stop the heating operation of the heating coil 3 with respect to the cooking container 2. However, even in the case of, for example, stir-frying, moisture comes out of a food material to be cooked during cooking depending on the kind or quantity of the food material and, hence, even if heating is continued, the temperature may be less likely to increase. Accordingly, even in the stir-frying, when the measured cooking time Tp has reached the initial set time T0, there is a chance that the detected temperature Tn may be less than or equal to the first set temperature Tepm1. In such a case, if heating is continued, a determination is made even in the stir-frying that scorching has occurred and heating is accordingly stopped during cooking.

In view of the above, in the induction-heating cooker according to the first embodiment, as shown in FIG. 5B, even if the scorching detecting portion 50 outputs the scorching detection signal B, the heating operation is continued for a given period of time because that does not negate the possibility of stir-frying. When the measured cooking time Tp after the start of cooking has reached a first set time T1, if the detected temperature Tn at that time is still greater than or equal to the second set temperature Tempt, the scorching detecting portion 50 determines the occurrence of scorching and makes the controller 15 stop the heating control, thereby stopping the heating operation with respect to the cooking container 2. If the induction-heating cooker is provided with a display or alarm, it is possible to inform the user of the discontinuance of the heating operation upon detection of the occurrence of scorching.

In general, the cooking by stewing usually requires a long period of time and other styles of cooking (for example, stir-frying) usually terminate within a short period of time compared with the stewing. For this reason, in the induction-heating cooker according to the first embodiment, the heating operation is continued until the first set time T1. By doing so, even if the cooking by, for example, stir-frying is incorrectly determined as the cooking by stewing, the possibility of stopping the heating operation before completion of the cooking can be reduced.

As can be seen from the above, in the cooking other than the stewing, discontinuance of the heating operation before completion of the cooking can be avoided with an increase in the first set time T1. However, if the first set time T1 is set to a very long period of time, a problem arises that if the food material is actually scorched during stewing, the scorching progresses. It is accordingly preferred in the cooking other than the stewing that the first set time T1 be set so as to be longer than a period of time within which completion of the cooking is generally estimated and as short as possible.

However, there is a chance that even if a food material is cooked over a relatively long period of time, such as when the cooking by, for example, stir-frying is incorrectly determined as the cooking by stewing and the food material is repeatedly cooked, the above-described control may incorrectly result in discontinuance of the heating operation.

As shown in FIG. 6A, if the detected temperature Tn exceeds the first set temperature Temp1, the detected temperature Tn normally increases continually in the case of scorching during stewing. However, if food materials are mixed or turned over during stir-frying or baking, the temperature of the bottom surface of the cooking container 2 changes and the detected temperature Tn reduces. If this reduction in the detected temperature Tn is determined as resulting from addition of a load by a determination means (described later) in the loading detecting portion 33, the cooking time Tp is reset and measurement thereof is restarted. In FIG. 6A, the detected temperature Tn exceeds the second set temperature Temp2 at the time of Td1 at which the cooking time Tp after the start of heating has reached T1 and, hence, the occurrence of scorching is to be determined. However, because addition of a load has been detected before that and measurement of the cooking time Tp is restarted upon resetting, the cooking time Tp does not reach the first set time T1 and, hence, a determination of scorching is not made. Thereafter, at the time of Td2 at which the cooking time Tp measured from the detection of addition of a load exceeds the first set time T1 and the detected temperature Tn exceeds the second set temperature Temp2, the scorching detecting portion 50 determines that scorching has occurred during stewing and outputs a scorching detection signal B.

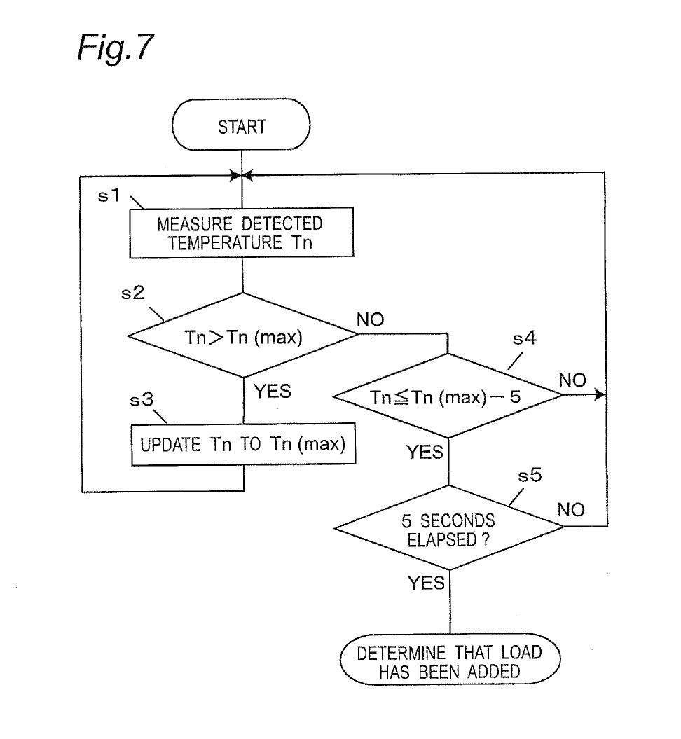

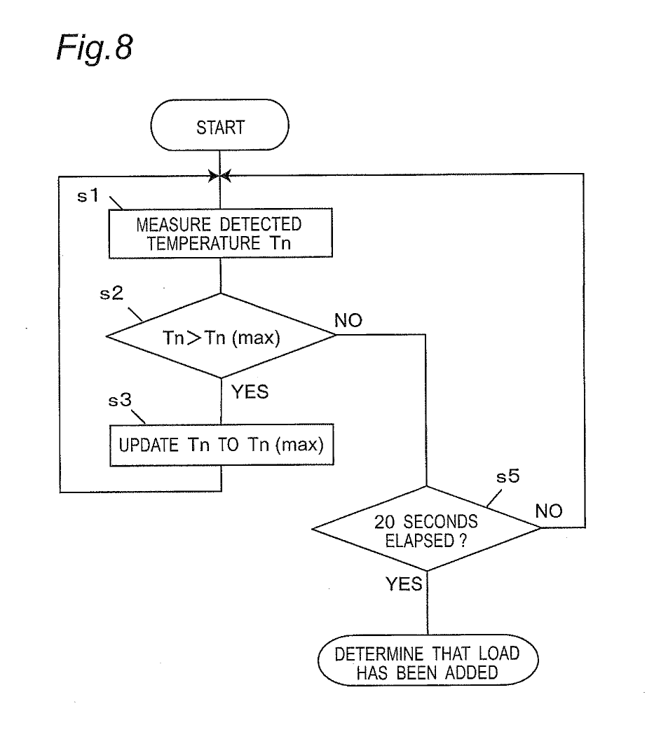

A method of determining addition of a load using the loading detecting portion 33 in the induction-heating cooker according to the first embodiment is explained hereinafter with reference to FIGS. 7 and 8. Each of FIGS. 7 and 8 is a flowchart indicating a loading detecting process to be performed in the loading detecting portion 33 based on a change in the detected temperature Tn calculated by the detected temperature calculating portion 30.

In FIG. 7, the detected temperature Tn is first detected (step s1). At step s2, a determination is made as to whether or not the temperature Tn detected at step s1 is greater than a maximum temperature Tn(max) measured by then. Because the detected temperature Tn continually increases in the case of scorching during stewing, the detected temperature Tn becomes greater than the maximum temperature Tn(max) and, for this reason, this step s2 is important to determine whether or not scorching has really occurred during stewing. If a determination is made at step s2 that the detected temperature Tn is greater than the maximum temperature Tn(max), the program advances to step s3 at which the detected temperature Tn is updated to the maximum temperature Tn(max).

On the other hand, if a determination is made at step s2 that the detected temperature Tn is less than or equal to the maximum temperature Tn(max), the program advances to step s4, at which a determination is made whether or not the detected temperature Tn is less than the maximum temperature Tn(max) by a predetermined temperature (5° C. in this embodiment) or more. That is, if food materials are mixed or a new food material is added during, for example, stir-frying, a temperature reduction normally occurs and, accordingly, a determination is made at this step whether or not a temperature change has occurred by reason of other than the scorching during stewing. If a determination is made that the detected temperature Tn is less than the maximum temperature Tn(max) by 5° C. or more, the program advances to step s5.

At step s5, a determination is made whether or not the temperature reduction of 5° C. or more at step s4 continues for a predetermined period of time (5 seconds in this embodiment) or more. In measuring the detected temperature Tn, the temperature may be instantaneously reduced by, for example, disturbance or a temperature reduction may occur for a very short period of time even during stewing due to, for example, repetition of boiling and evaporation of water in the course of scorching of the material to be cooked. For this reason, step s5 is necessary to detect real introduction of a load into the cooking container 2 without erroneously determining such a phenomenon.

If a determination is made at step s5 that a temperature reduction of 5° C. or more continues, a determination is made that a load has been added.

A flowchart of FIG. 8 differs from the flowchart of FIG. 7 indicating the detection of load addition in that step s4 in FIG. 7 does not exist in FIG. 8 and the period of time for determination at step s5 in FIG. 7 is lengthened in FIG. 8. Because the flowchart of FIG. 8 is the same as that of FIG. 7 in other contents, explanation thereof is omitted.

At step s2 in FIG. 8, a determination is made whether or not the detected temperature Tn detected at step s1 is greater than the maximum temperature Tn(max) measured by then. If a determination is made at step s2 that the detected temperature Tn is less than or equal to the maximum temperature Tn(max), the program advances to step s5, at which a determination is made whether or not a state in which the detected temperature Tn is less than or equal to the maximum temperature Tn(max) at step s2 continues for a predetermined period of time (20 seconds in this embodiment). When, for example, a pancake or okonomiyaki is turned over after one side thereof has been baked, a large temperature reduction does not occur because it has been cooked to some extent. This step s5 deals with a case where the temperature does not increase unless heating is continued for a while. The period of time is set to 5 seconds in FIG. 7 and to a period of time longer than it in a pattern of FIG. 8.

If a determination is made at step s5 that a state of no temperature increase continues over 20 seconds, a determination is made that a load has been added.

As described above, in the induction-heating cooker according to the first embodiment, whether a food material is being cooked by stewing or any other style of cooking (for example, stir-frying) is determined in the scorching detecting portion 50 of the controller 15, and when the detected temperature Tn reaches the second set temperature Temp2 during stewing, the scorching detecting portion 50 outputs scorching detection information (scorching detection signal B). Also, if the cooking time Tp measured by the first time measuring portion 31 exceeds the first set time T1, heating of the cooking container 2 by the heating coil 3 is stopped, and if a determination is made by the loading detecting portion 33 that a load has been added, the measured cooking time Tp is reset and time measurement is started again. By doing so, even if the cooking by stir-frying or baking is erroneously determined as the cooking by stewing, heating can be continued until the cooking is completed.

Although in the induction-heating cooker according to the first embodiment an output voltage of the infrared sensor 4 is converted into a temperature in the detected temperature calculating portion 30, the present invention is not limited to such a construction and similar effects can be obtained even if the heating power is directly controlled based on the output voltage of the infrared sensor 4.

Also, although in the induction-heating cooker according to the first embodiment the output setting is assumed as setting 4 (1000 W), the present invention is not limited to this and a similar control can be performed even at another setting. Further, if the initial set time T0, the first set time T1, and the threshold values of the detected temperature Tn of the infrared sensor 4, i.e., the first set temperature Temp1 and the second set temperature Temp2 are each set to an appropriate value for each output setting, a more accurate control can be performed.

Also, if the initial set time T0, the first set time T1, and the threshold values of the detected temperature Tn of the infrared sensor 4, i.e., the first set temperature Temp1 and the second set temperature Temp2 are each set to an appropriate value depending on the kind of a metal material of the cooking container 2 that can be determined based on information (for example, a turn-on time of the switching element 11, an electric current flowing through the heating coil 3, a frequency for controlling the switching element 11, an electric current supplied to the inverter circuit 8, and the like) from the inverter circuit 8, a more accurate determination can be made. This is because various characteristics such as, for example, a thermal conductivity differ depending on the kind of metal material as well as the size of the cooking container 2 and the degree of progress of scorching differs depending on a difference in, for example, thermal conductivity.

Further, although in the induction-heating cooker according to the first embodiment a limit is not set on the output setting, it is preferred that the scorching detection function for stewing be active only when the output setting is below a predetermined value. The reason for this is that as the power increases, it becomes difficult to differentiate between the cooking by stewing and other styles of cooking (for example, stir-frying) based on only the detected temperature of the infrared sensor 4. If a value set by the power setting portion 14b of the operating portion 14 is greater than a predetermined value, the scorching detecting function can be made inactive under the control of the controller 15.

Also, in the induction-heating cooker according to the first embodiment, the heating operation is stopped after the detection of scorching has been determined, but the present invention is not limited to such a construction and it is sufficient if the progress of scorching is constricted. By way of example, the heating operation may be continued at an output corresponding to a heating power at the time of heat-retention, e.g., at an output of from about 100 W to about 200 W.

In addition, in the induction-heating cooker according to the first embodiment, when the cooking time from the start of heating reaches the first set time T1, the detection of scorching is determined, but the present invention is not limited to such a case and the determination may be made when an integral power consumption from the start of heating reaches a predetermined value. This predetermined value may be changed depending on the kind of the metal material of the cooking container 2, which can be determined based on the information from the inverter circuit 8, to further enhance the accuracy. This is because various characteristics such as, for example, a thermal conductivity differ depending on the kind of the metal material of the cooking container 2 and the degree of progress of scorching differs depending on a difference in, for example, thermal conductivity. Another big reason for this is that the thermal efficiency of the power supplied from the inverter circuit 8 to the cooking container 2 differs depending on the kind of the metal material.

In the induction-heating cooker according to the first embodiment, because the infrared sensor 4 for use in detecting the temperature of the bottom surface of the cooking container 2 is responsive to the bottom surface temperature compared with a thermosensor such as a thermistor, scorching can be highly accurately detected.

Also, in the induction-heating cooker according to the first embodiment, when addition of a load is detected by the loading detecting portion 33, the measured cooking time Tp is reset and time measurement is started again, but the present invention is not limited to this. If a control to make the scorching detection function as inactive as possible is desired, the scorching detection function may not work while heating is continued after the detection of load addition.

### Embodiment 2

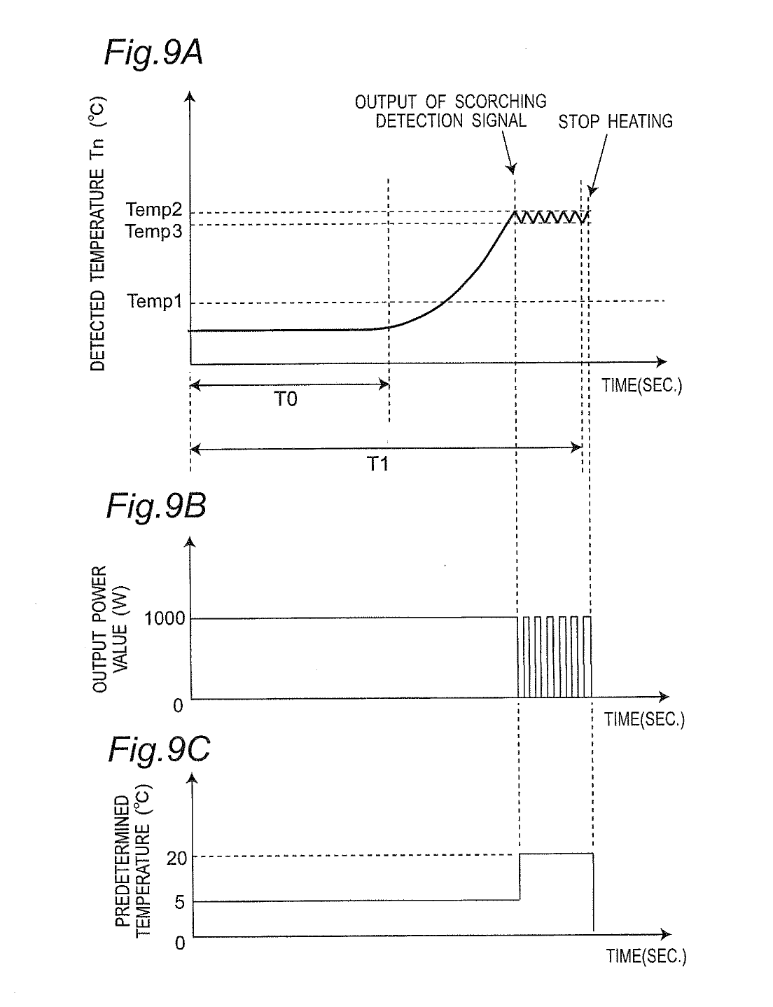

An induction-heating cooker according to a second embodiment of the present invention is explained hereinafter with reference to FIGS. 1 to 4 referred to above and FIGS. 9A to 9C. Constituent elements having the same function and the same construction as those in the induction-heating cooker according to the first embodiment are designated by the same reference numerals and explanation thereof is omitted.

In the induction-heating cooker according to the second embodiment,

FIG. 9A is a graph showing an example of a relationship between the detected temperature Tn (° C.) of the infrared sensor 4 and the elapsed time (sec.) after the start of heating, FIG. 9B is a graph showing an example of a relationship between the output power (W) and the elapsed time (sec.) after the start of heating, and FIG. 9C is a graph showing an example of a relationship between a predetermined value (° C.) of a temperature reduction for determination of addition of a load and the elapsed time (sec.) after the start of heating.

In FIGS. 9A, 9B and 9C, when the detected temperature Tn reaches the second set temperature Temp2, the scorching detecting portion 50 outputs a scorching detection signal B. However, because the measured cooking time Tp from the start of heating does not reach the first set time T1, the controller 15 does not stop a heating control, but if heating is continued at the same output power (1000 W in the second embodiment), the temperature of the cooking container 2 continues to increase. In the case of scorching during stewing, the scorching progresses from bad to worse.

In the induction-heating cooker according to the second embodiment, in order to avoid such a situation, when the detected temperature Tn reaches the second set temperature Temp2, the heating operation is turned off. As a result, the detected temperature Tn reduces and reaches a third set temperature Temp3 lower than the second set temperature Temp2 (in the second embodiment, the third set temperature Temp3 is lower than the second set temperature Temp2 by 5° C.), the heating operation is turned on again. That is, a temperature control is performed such that the detected temperature Tn may not exceed the second set temperature Temp2. When the measured cooking time Tp from the start of heating reaches the first set time T1 and the detected temperature Tn reaches the second set temperature Temp2, the occurrence of scorching during stewing is determined and the controller 15 stops the heating control to stop the heating operation with respect to the cooking container 2.

During the temperature control referred to above, there is a possibility that a temperature reduction in which the detected temperature Tn reduces over a predetermined temperature will continue for a predetermined period of time and the loading detecting portion 33 determines that a load has been added. In such a case, the measured cooking time Tp is cleared and the scorching detection does not function indefinitely despite a state of scorching during stewing.

In the second embodiment of the present invention, in order to avoid such a situation, when the detected temperature Tn reaches the second set temperature Temp2 and the temperature control is started, the predetermined value of the detected temperature reduction, based on which the loading detecting portion 33 determines that a load has been added, is increased. In this embodiment, as shown in FIG. 9C, the predetermined value is increased from 5° C. to 20° C.

As described above, in the induction-heating cooker according to the second embodiment, the scorching detecting portion 50 in the controller 15 determines the cooking by stewing or any other style of cooking (for example, stir-frying), and when the detected temperature Tn reaches the second set temperature Temp2 during stewing, the temperature is controlled so as not to exceed the second set temperature Temp2 and the scorching detecting portion 50 outputs scorching detection information (scorching detection signal B). Also, the predetermined value of the detected temperature reduction, based on which the loading detecting portion 33 determines that a load has been added, is increased (i.e., a criterion for detecting addition of a load is increased). The induction-heating cooker according to the second embodiment is constructed such that when the cooking time Tp measured by the first time measuring portion 31 exceeds the first set time T1, heating of the cooking container 2 by the heating coil 3 is stopped. Because the induction-heating cooker according to the second embodiment is constructed as described above, even if the cooking by stir-frying is erroneously determined as the cooking by stewing, heating can be continued until the cooking is completed and, also, the progress of scorching during stewing can be constricted.

In the induction-heating cooker according to the second embodiment, when the detected temperature Tn reaches the second set temperature Temp2 after the measured cooking time Tp has reached the first set time T1, the detection of scorching is determined, but because the temperature is controlled, for example, after the detected temperature Tn has reached the second set temperature Temp2, the detection of scorching may be determined (for example, display of the scorching) when the measured cooking time Tp has reached the first set time T1.

Also, in the induction-heating cooker according to the second embodiment, after the detected temperature Tn has reached the second set temperature Temp2, the temperature is controlled so as not to exceed the second set temperature Temp 2 until the measured cooking time Tp from the start of cooking reaches the first set time T1, but the present invention is not limited to such a construction. Similar effects can be obtained if the heating power can be variably controlled, for example, depending on gradients or absolute values of temperature changes of the detected temperature Tn (for example, fuzzy control). Further, although the temperature control has been described as on-off controlling the heating operation, the temperature control may be performed, for example, by changing the heating power without turning off the heating operation.

### Embodiment 3

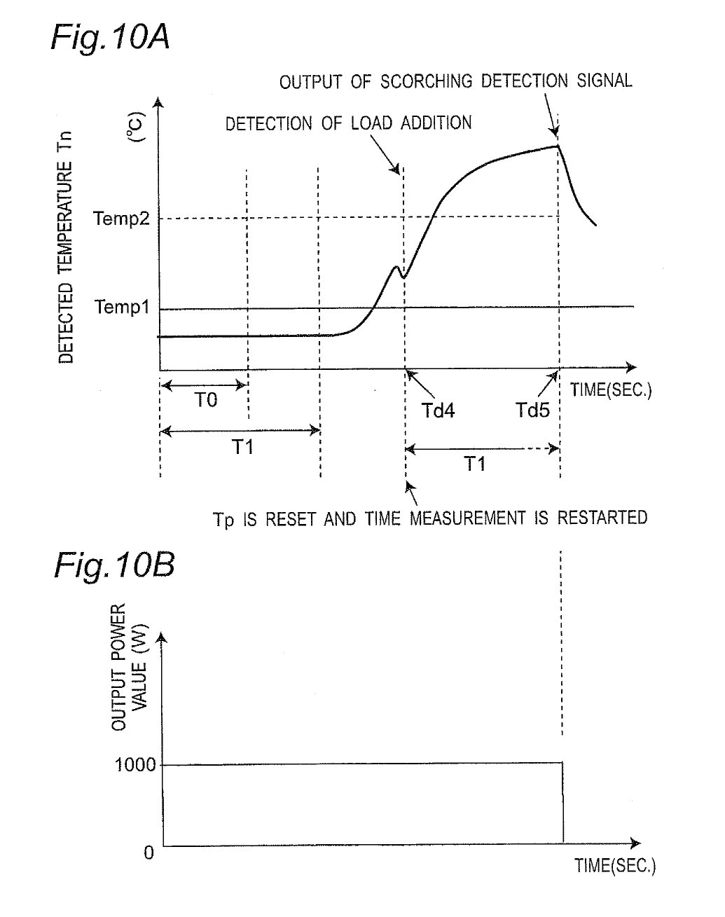

An induction-heating cooker according to a third embodiment of the present invention is explained hereinafter with reference to FIGS. 1 to 4 referred to above and FIGS. 10A and 10B. Constituent elements having the same function and the same construction as those in the induction-heating cooker according to the first and second embodiments are designated by the same reference numerals and explanation thereof is omitted.

In the induction-heating cooker according to the third embodiment, FIG. 10A is a graph showing an example of a relationship between the detected temperature Tn (° C.) of the infrared sensor 4 and the elapsed time (sec.) after the start of heating and FIG. 10B is a graph showing an example of a relationship between the output power (W) and the elapsed time (sec.) after the start of heating.

In the graph of FIG. 10A, even if the initial set time T0 has elapsed after the start of heating, the detected temperature Tn of the infrared sensor 4 is less than or equal to the first set temperature Temp1 and, hence, the scorching detecting portion 50 determines that cooking is being done by stewing at this stage. After a continuous heating operation, when the measured cooking time Tp exceeds the first set time T1 and the detected temperature Tn then reaches the second set temperature Temp2, the scorching detecting portion 50 outputs scorching detection information (scorching detection signal B) and the controller 15 stops a heating control to thereby merely stop the heating operation with respect to the cooking container 2.

If a determination is made by the loading detecting portion 33 that a load such as a food material or materials to be cooked has been added after the measured cooking time Tp has exceeded the first set time T1, the measured cooking time Tp is reset and time measurement is started again (at the time of Td4). Thereafter, when the measured cooking time Tp so restarted exceeds the first set time T1 again and the detected temperature Tn reaches the second set temperature Temp2, the scorching detecting portion 50 outputs scorching detection information (scorching detection signal B) and the controller 15 stops the heating control to stop the heating operation with respect to the cooking container 2.

As described above, in the induction-heating cooker according to the third embodiment, the scorching detecting portion 50 determines the cooking by stewing or any other style of cooking (for example, stir-frying), and when the loading detecting portion 33 detects addition of a load after the measured cooking time Tp from the start of heating has exceeded the first set time T1, measurement of the cooking time Tp is restarted. By doing so, even if the cooking by stir-frying or baking is erroneously determined as the cooking by stewing in the case of relatively long-time cooking, the loading detecting portion 33 detects a temperature reduction that may occur, for example, when food materials are mixed during stir-frying or turned over during baking, and heating is continued for the first set time. As such, even if the cooking by stir-frying or baking is erroneously determined as the cooking by stewing, a problem can be avoided in which the scorching detection is determined before completion of the cooking and the heating operation is stopped.

Although in the induction-heating cooker according to the third embodiment the heating is continued even after the detected temperature Tn has reached the second set temperature Temp2, the present invention is not limited to such a construction and the temperature may be controlled by the controller 15 so as not to exceed the second set temperature Temp2 before the measured cooking time Tp reaches the first set time T1.

### Embodiment 4

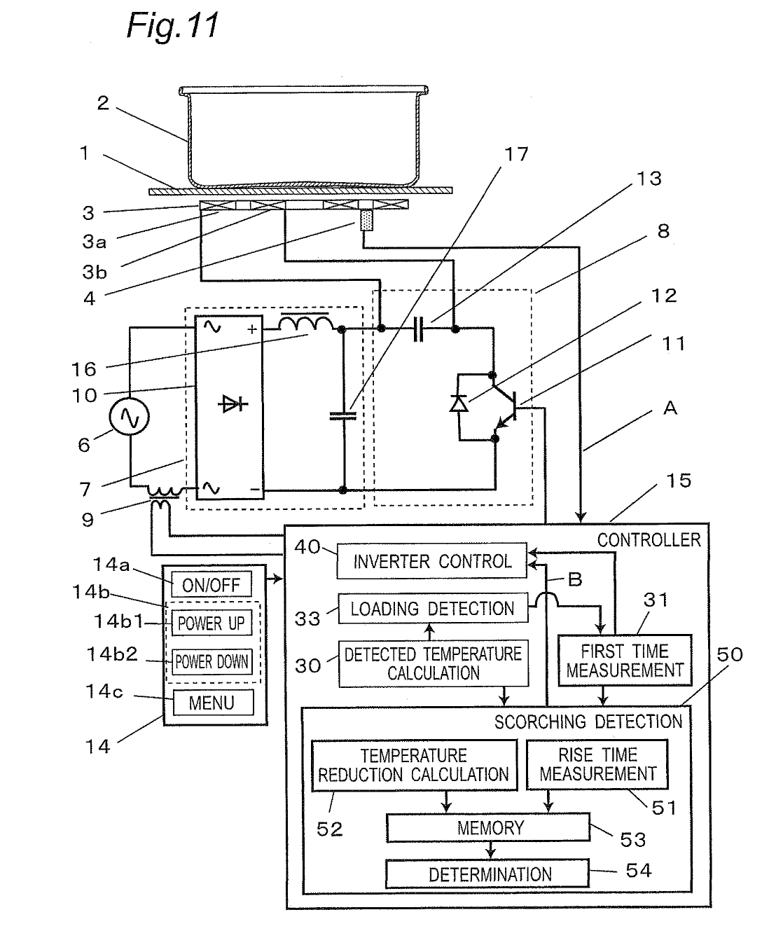

An induction-heating cooker according to a fourth embodiment of the present invention is explained hereinafter with reference to FIGS. 2 to 4 referred to above, FIGS. 11 and 12, and FIGS. 13A and 13B. Constituent elements having the same function and the same construction as those in the induction-heating cooker according to the first and second embodiments are designated by the same reference numerals and explanation thereof is omitted.

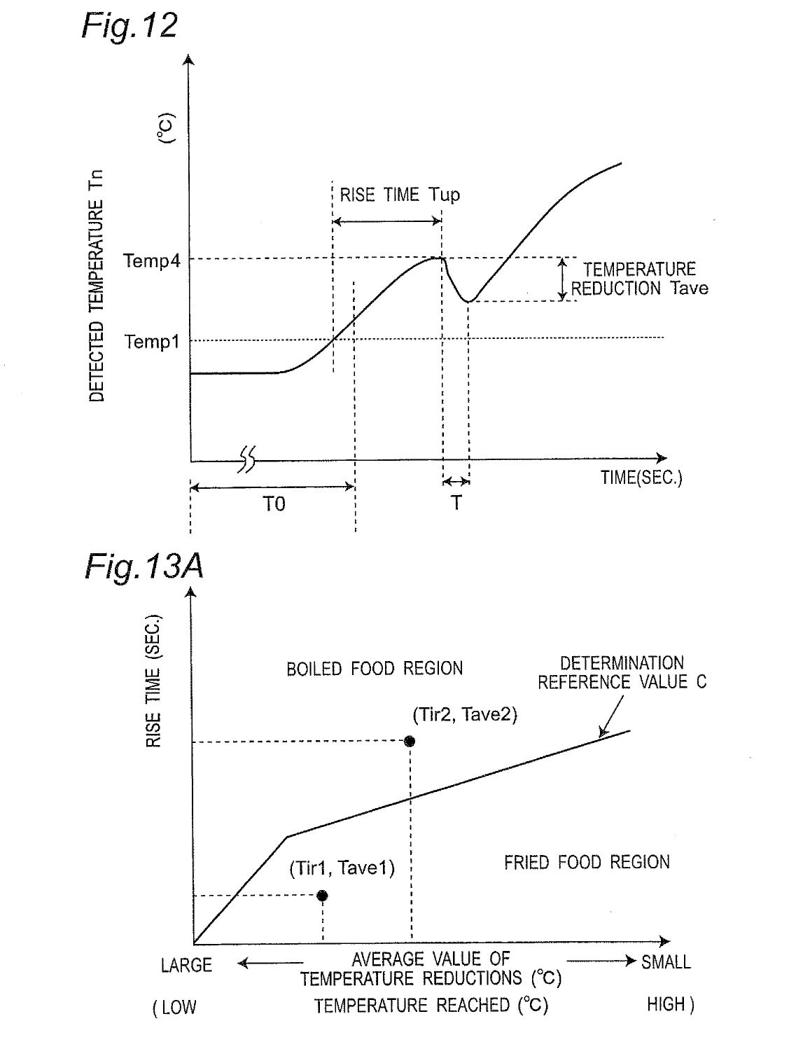

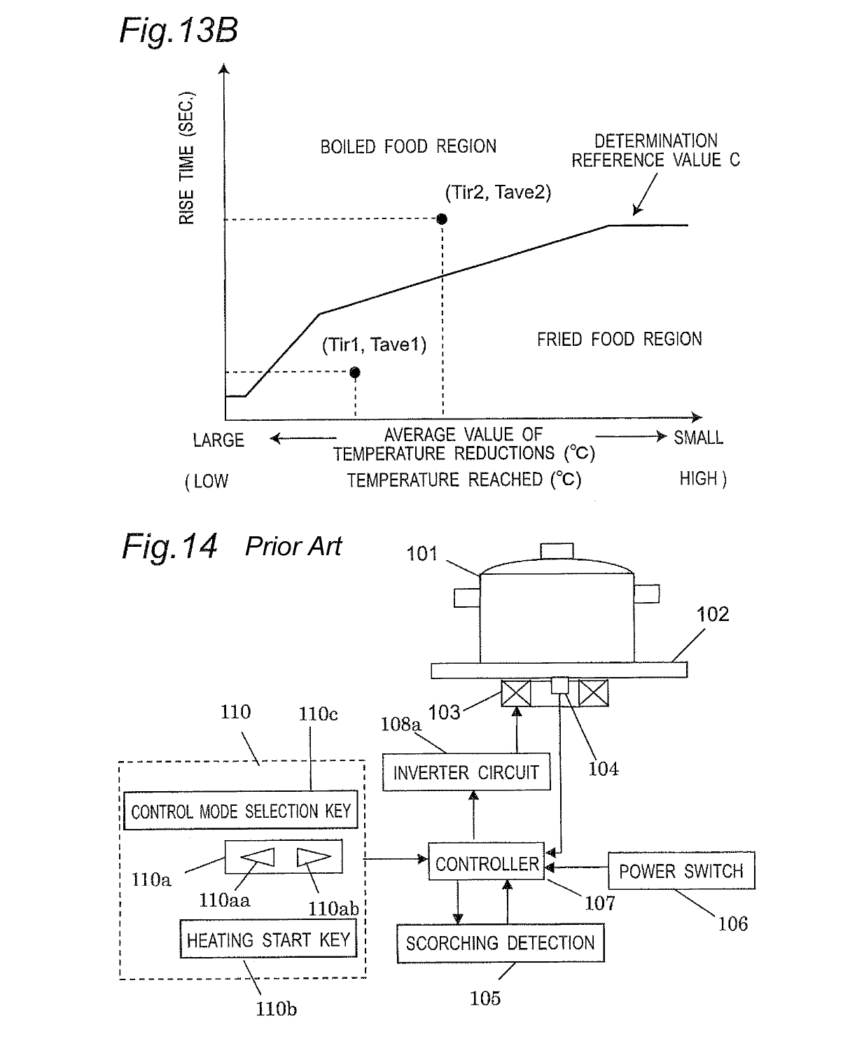

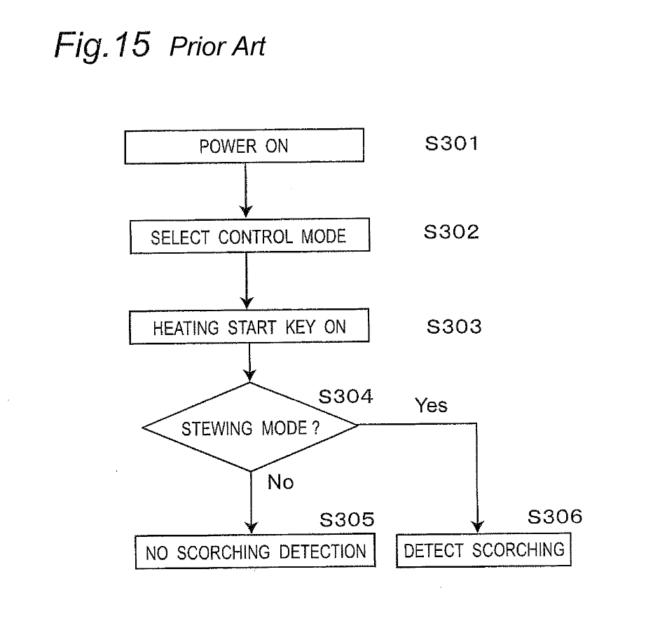

FIG. 11 is a block diagram showing an entire construction of the induction-heating cooker according to the fourth embodiment of the present invention. FIG. 12 is a graph showing an example of a rise time measuring operation and a temperature reduction calculating operation of the scorching detecting portion 50 in the induction-heating cooker according to the fourth embodiment. FIGS. 13A and 13B are graphs to explain a scorching detecting operation of the scorching detecting portion 50 in the induction-heating cooker according to the fourth embodiment, each showing an example of determination values.

In the induction-heating cooker according to the fourth embodiment as shown in FIG. 11, the scorching detecting portion 50 includes a rise time measuring portion 51 for measuring a rise time of the detected temperature Tn of the infrared sensor 4, a temperature reduction calculating portion 52 for calculating a temperature reduction of the detected temperature Tn within a predetermined period of time after the heating operation has been stopped, a memory portion 53 for memorizing values obtained by the rise time measuring portion 51 and the temperature reduction calculating portion 52, and a determining portion 54 for calculating a determination value from the values obtained by the rise time measuring portion 51 and the temperature reduction calculating portion 52 and then determining whether a food material or materials are being cooked by stewing or any other style of cooking based on the determination value. The controller 15 includes, in addition to the inverter control portion 40, the first time measuring portion 31 and the detected temperature calculating portion 30, a loading detecting portion 33 for detecting addition of a load such as a food material to be cooked to the cooking container 2 based on a change in the detected temperature Tn detected by the detected temperature calculating portion 30.

How to differentiate between the cooking by stewing and any other styles of cooking in the induction-heating cooker according to the fourth embodiment is explained hereinafter with reference to FIGS. 12 and 13A.

If the bottom temperature of the cooking container 2 being heated at, for example, setting 4 (1000 W) increases, the detected temperature Tn of the infrared sensor 4 starts to increase. Even if the detected temperature Tn as shown in FIG. 12 reaches the first set temperature Temp1, a determination cannot be made that the cooking by stewing is being done before the cooking time Tp measured from the start of heating reaches the initial set time T0. For this reason, the cooking by stewing and any other styles of cooking (for example, stir-frying) are differentiated based on an increase or decrease in the detected temperature Tn. A method of differentiating is explained hereinafter.

Firstly, the rise time measuring portion 51 measures a rise time Tup required for the detected temperature Tn to increase from the first set temperature Temp1 (° C.) to a fourth set temperature Temp4 (° C.). It is preferred that the fourth set temperature Temp4 be less than or equal to the second set temperature Temp2 at which scorching is detected. In the fourth embodiment, the fourth set temperature Temp4 is set to 160° C. The heating operation is retained stopped for a predetermined period of time T (for example, 10 seconds) after the detected temperature Tn has reached the fourth set temperature Temp4. The temperature reduction calculating portion 52 then calculates a temperature reduction in the bottom temperature of the cooking container 2 within the predetermined period of time T during which the heating operation is at a stop. The temperature reduction can be obtained not only by merely calculating how much the detected temperature Tn is reduced from the fourth set temperature Temp4 after a lapse of the predetermined period of time T, but also by calculating a temperature which the bottom temperature of the cooking container 2 will reach after a lapse of the predetermined period of time T from when the heating operation has been stopped. In the induction-heating cooker according to the fourth embodiment, the temperature reduction is obtained by measuring a temperature reduction per second and then calculating an average value Tave of temperature reductions for ten seconds.

Operation of the determining portion 54 in the scorching detecting portion 50 is next explained with reference to FIGS. 13A and 13B. In FIG. 13A, a vertical axis indicates the rise time (sec.) measured by the rise time measuring portion 51 and a horizontal axis indicates the average value (° C.) of the temperature reductions calculated by the temperature reduction calculating portion 52.

Determination reference values C of the rise time and the average value of the temperature reductions as shown in FIG. 13A are determined in advance depending on a specification of the induction-heating cooker. As shown in FIG. 13A, a region above a boundary line of the determination reference values C is defined as a boiled food region and a region below the boundary line of the determination reference values C is defined as a fried food region. A region on the boundary line of the determination reference values is the boiled food region. The extent of the temperature reduction at the time of stoppage of the heating operation has a correlation with a thickness of the cooking container. Because a thermal capacity increases with an increase in thickness of the cooking container, the temperature reduction becomes gradual. If the thickness of the cooking container is supposed to be substantially negligible, the rise time is long in the case of a boiled food and short in the case of a fried food. Accordingly, the boiled food and the fried food can be differentiated based on a predetermined rise time.

However, it is actually necessary to consider the thickness of the cooking container and, as described above, even in the case of the same fried food, the rise time increases with an increase in thickness of the cooking container. Accordingly, as shown in FIG. 13A, the boundary line between the boiled food region and the fried food region inclines upwards from left to right with an increase in thickness of the cooking container.

After the rise time Tir measured by the rise time measuring portion 51 of the scorching detecting portion 50 and the average value Tave of the temperature reductions calculated by the temperature reduction calculating portion 52 of the scorching detecting portion 50 have been both determined, the determining portion 54 determines whether food materials are being cooked by stewing or any other style of cooking (for example, stir-frying) based on the determination reference values C shown in FIG. 13A. If the rise time Tir from the rise time measuring portion 51 and the average value Tave of the temperature reductions from the temperature reduction calculating portion 52 have been determined as a coordinate value (Tir1, Tave1) lying in the region below the boundary line of the determination reference values C in FIG. 13A, a determination is made that the food materials are being cooked by stir-frying and heating is continued without any scorching detection.

On the other hand, if the rise time Tir from the rise time measuring portion 51 and the average value Tave of the temperature reductions from the temperature reduction calculating portion 52 correspond to a coordinate (Tir2, Tave2) lying in the region above the boundary line of the determination reference values C, a determination is made that the food materials are being cooked by stewing. In the case of the determination as the cooking by stewing, when the detected temperature Tn reaches the second set temperature Temp2 (° C.) and the cooking time Tp measured from the start of heating exceeds the first set time T1, a determination is made that scorching has been detected and the controller 15 stops the heating control to stop the heating operation with respect to the cooking container 2. Also, in the case of the determination as the cooking by stewing, when the loading detecting portion 33 detects that a load has been added during heating, the cooking time Tp measured from the start of heating is cleared and measurement thereof is restarted.

In the induction-heating cooker of the above-described construction according to the fourth embodiment, the scorching detecting portion 50 determines the cooking by stewing or any other style of cooking (for example, stir-frying) and outputs scorching detection information (scorching detection signal B) when the detected temperature Tn reaches the second set temperature Temp2 during stewing. Also, when the cooking time Tp measured by the first time measuring portion 31 exceeds the first set time T1, the heating operation by the heating coil 3 with respect to the cooking container 2 is stopped. By doing so, even if the cooking by stir-frying is erroneously determined as the cooking by stewing, the heating operation is continued until the cooking is completed. Also, when the bottom temperature of the cooking container 2, which is being heated at, for example, setting 4 (1000 W), increases and the temperature measured by the infrared sensor 4 starts to increase, the rise time measuring portion 51 in the scorching detecting portion 50 measures a rise time Tup from the first set temperature Temp1 (° C.) to the fourth set temperature Temp4 (° C.), thereby making it possible to differentiate between the cooking by stir-frying that is short in the rise time and the cooking by stewing that is long in the rise time. Further, the heating operation is retained stopped for a predetermined period of time T (for example, 10 seconds) after the detected temperature Tn has reached the fourth set temperature Temp4 (° C.), and the temperature reduction calculating portion 52 then calculates, for example, a temperature reduction per second (average value Tave of the temperature reductions for 10 seconds) in the bottom temperature of the cooking container 2, thereby making it possible to estimate a thickness of a bottom wall of the cooking container 2 in use. Accordingly, the cooking by stewing and the cooking by stir-frying can be differentiated with a high degree of accuracy using a relationship between the rise time and the thickness of the bottom wall of the cooking container 2 that is estimated from the temperature reductions, the relationship being indicated by a substantially linear proportional expression (boundary line of determination reference values C) as shown in FIG. 13A.

Considering a range of thicknesses of cooking containers to be normally used, as shown in FIG. 13B, the boundary line of the determination reference values may be constant if the thickness is below a certain value or exceeds another certain value.

Moreover, as shown in FIGS. 13A and 13B, the horizontal axis may indicate a temperature that is reached after a lapse of a predetermined period of time. Similarly, the vertical axis may indicate a temperature reduction per second.

Although in FIG. 13A an inclination of the boundary line of the determination reference values is not constant, this is because different materials are used depending on the thickness of the cooking container and, hence, the inclination is determined, having regard to the fact that the thermal conductivity differs. That is, stainless steel is generally used for the cooking container in applications where the thickness thereof is below a given value and because stainless steel has a low thermal conductivity and the rise time accordingly increases, the inclination is made large.

As described above, even if cooking is being done in the heating mode in which the user can freely select the heating power, the scorching detection function can be made active if necessary and inactive if it may be unnecessarily activated to adversely affect the cooking. Also, even if the cooking by stir-frying or baking is erroneously determined as the cooking by stewing, the loading detecting portion 33 detects a temperature reduction, which may occur, for example, when food materials are mixed or turned over during stir-frying or baking, and the heating is continued for the first set time, thereby making it possible to avoid a problem that the scorching detection is determined before completion of the cooking and the heating operation is stopped. Accordingly, the present invention can provide a user-friendly induction-heating cooker that can not only suppress adverse effects during normal cooking in the heating mode, but also prevent the extent of scorching from becoming worse.

### INDUSTRIAL APPLICABILITY

The induction-heating cooker according to the present invention can detect scorching in an operation mode in which heating is performed at an output selected by the user and continuously cook a food material or materials without unnecessarily activating the scorching detection function during cooking such as, for example, stir-frying. Accordingly, the induction-heating cooker according to the present invention can be widely used as a cooking device for home use or business use in the form of, for example, a built-in cooking device, a desktop one for use on a table, or a stationary one for use on a pedestal.

### EXPLANATION OF REFERENCE NUMERALS

1 top plate
2 cooking container
3 heating coil (induction-heating coil)
4 infrared sensor
8 inverter circuit
14 operating portion
15 controller
31 first time measuring portion
33 loading detecting portion
40 inverter control portion
50 scorching detecting portion
51 rise time measuring portion
52 temperature reduction calculating portion
53 memory portion
54 determining portion

1. An induction-heating cooker comprising:
a top plate adapted to place a cooking container thereon;
an inverter circuit disposed below the top plate and having a heating coil to heat the cooking container;
an infrared sensor disposed below the top plate to detect infrared rays that are emitted from a bottom surface of the cooking container and pass through the top plate, the infrared sensor outputting infrared detection information corresponding to a temperature of the bottom surface of the cooking container;
a scorching detecting portion operable to detect scorching, in which a material to be cooked has burnt and stuck to the bottom surface of the cooking container, based on the infrared detection information, the scorching detecting portion outputting scorching detection information;
an output setting portion operable to select one of a plurality of different power set values; and
a controller operable to supply the heating coil with a high-frequency current and control a heating operation of the inverter circuit such that a heating power becomes a power set value selected, the controller comprising:
a first time measuring portion operable to measure a cooking time from the start of heating by the inverter circuit; and
a loading detecting portion operable to detect addition of a load to the cooking container based on the infrared detection information outputted from the infrared sensor;
wherein if the cooking time measured by the first time measuring portion does not reach a first set time, the heating operation is continued even if the scorching detecting portion outputs the scorching detection information, and when the loading detecting portion detects that the load has been added, the cooking time measured by the first time measuring portion is reset and measurement thereof is restarted.

2. The induction-heating cooker according to claim 1, wherein the loading detecting portion determines that the load has been added when a state in which the infrared detection information detected by the infrared sensor reduces a predetermined value or more continues for a predetermined period of time.

3. The induction-heating cooker according to claim 1, wherein the loading detecting portion determines that the load has been added unless the infrared detection information detected by the infrared sensor increases for a predetermined period of time or more.

4. The induction-heating cooker according to claim 1, wherein if the cooking time measured by the first time measuring portion is below the first set time and when the scorching detecting portion outputs the scorching detection information, the controller controls the heating operation of the inverter circuit for temperature control such that the infrared detection information approaches a second set value without exceeding the second set value, and a criterion of the loading detecting portion for detecting addition of the load is increased compared with a case where no temperature control is conducted.

5. The induction-heating cooker according to claim 1, wherein if the loading detecting portion detects that the load has been added after the cooking time measured by the first time measuring portion has exceeded the first set time, the cooking time measured by the first time measuring portion is reset and measurement thereof is restarted.
